(19) United States
(12) Patent Application Publication
(10) Pub. No.: US 2025/0208016 A1
(43) Pub. Date: Jun. 26, 2025

(54) NOVEL METHOD FOR MEASURING SURFACE AREA

(71) Applicant: CiDRA Corporate Services LLC, Wallingford, CT (US)

(72) Inventors: Timothy J. BAILEY, Longmeadow, MA (US); Michael Stephen RYAN, Newtown, CT (US); Mark FERNALD, Enfield, CT (US)

(21) Appl. No.: 18/852,790

(22) PCT Filed: Apr. 25, 2023
(86) PCT No.: PCT/US2023/019730

§ 371 Date: Sep. 30, 2024

Related U.S. Application Data
(60) Provisional application No. 63/334,284, filed on Apr. 25, 2022.

(51) Int. Cl. G01N 15/08

(52) U.S. Cl. CPC G01N 15/0893; G01N 2015/0833

(57) ABSTRACT

Apparatus or a method for measuring a surface area of collection media having a collection surface, including a collection surface having a complex surface like reticulated foam, that includes steps of: rendering the collection surface hydrophobic, contacting the collection surface with an aqueous mixture containing hydrophobic particles so as to achieve a single layer of the hydrophobic particles on the collection surface, and determining the surface area based on the number or mass of the hydrophobic particles in the single layer. The hydrophobic particles may include mineral particles. The collection surface may include a foam, or a three-dimensional open-cell structure. The method may include determining and comparing the mass of the collecting surface without the single layer and the mass of the collection surface with the single layer. The method may include functionalizing the collection surface with poly(dimethylsiloxane), fluoroarylsilane. The collection surface may be made of a hydrophobic material.

### CROSS-REFERENCE TO RELATED APPLICATIONS

This application claims benefit to provisional application Ser. No. 63/334,284, filed 25 Apr. 2022 (Docket no. 712-002.469/CCS-0218), entitled “Method for measuring surface area for collection media,” which is hereby incorporated by reference in its entirety.

### 1. FIELD OF THE INVENTION

This invention relates generally to a method and apparatus for measuring the surface area of collection media, e.g., used in the mining industry.

### 2. DESCRIPTION OF RELATED ART

Surface area is an extremely important property of materials that often contributes to important performance parameters. The surface area of fine porous particles such as activated carbon, zeolites, and the like is typically measured using gas adsorption via the BET (Brunauer-Emmett-Teller) method. Most typically, nitrogen is used; however, in some cases where pores are very small, Krypton is used as it's a smaller molecule. In other cases, a liquid may be used such as ethylene glycol monoethyl ether (EGME) (Journal of Testing and Evaluation, Vol 25, Issue 3). In this case, soil is saturated with EGME and then vacuum desiccated until a monolayer is achieved. These methods are used to find the surface area of fine, often porous, particles but isn't useful for determining surface area of larger objects.

For larger geometric objects, surface area may be easily determined by measuring the faces and calculating the area. However, for larger objects that aren't geometric—i.e., have uneven and variable structure, surface area measurement is more difficult. Various techniques have been proposed such as dipping in liquid and measuring the mass change to give a relative surface area; however, there is no good way to control the thickness of the liquid; particularly due to surface tension as it would well up in tighter areas. Photomicrography may be used to take measurements of some of the areas and then estimate by scaling-up the values; however, this is quite inexact.

In view of the aforementioned, there is a need in the industry for a better way for measuring surface area of collection media.

### SUMMARY OF THE INVENTION

In the present invention, and by way of example, surface area is measured by adhering a monolayer of hydrophobic particles onto a complex surface. The mass of the particles is measured and correlated with surface area. This is a simple method that doesn't require any expensive, specialized equipment and delivers accurate results. It is widely applicable to all macroscopic objects including those with complex geometries and macroscopic pore structures such as reticulated polymeric foams.

### Example 1: Reticulated Foams Having Complex Surface Areas

In a first example, ten grams of a chalcopyrite mineral that has been rendered hydrophobic via reaction with potassium amyl xanthate and has particle size such that 80% w/w is smaller than 100 microns (P80<100 μm) is dispersed in 500 mL of tap water. 100 half-inch cubes of reticulated polyurethane foam which has been coated in a hydrophobic coating are weighed to four decimal places and then added to the mineral dispersion and shaken for one-minute. The cubes are removed and shaken in water to remove any non-attached particles. The cubes are then removed from the water with the excess water fully drained from the cubes. The mineral-laden cubes are then dried in an oven at 95 C and then equilibrated at room conditions for one-hour. The dry and equilibrated cubes are then weighed to four decimal places. The amount of mineral collected on the cubes is then calculated. This mass may be used to provide relative surface area information or may be compared to known surface areas to develop a calibration curve with unknowns interpolated from that information.

In FIG. 1, the mass of mineral collected on four different coated reticulated foams vs the known surface area of the base foams is graphed. The relationship between the foam surface area and the mass of mineral collected is extremely linear with an R² of 0.9999.

Unknown foams were then measured and found to have a mass of 7.59 g and 6.22 g corresponding to a surface area of 2171 m2/M3 and 1749 m2/M3 respectively.

One of the foams was repeated using 100 different cubes from the same foam batch. In the first test, 7.50 g was collected while the second test resulted in 7.97 g collected. This resulted in surface area calculations of 2142 m2/M3 and 2286 m2/M3 respectively; an error of just 6.7%. However, as reticulated foams are naturally variable, the result may be closer to accurate.

### Example 2: Multiple Materials with Different Known Surface Areas

In a second example, multiple materials with different known surface areas are sprayed with a thin coating of silicone polymer, dried, and weighed. The materials are placed into a dispersion of fine hydrophobic particles, rinsed, dried, and weighed. The collected masses are correlated to the known surface areas. This data is used to complete a calibration curve for use with unknown materials. This procedure is then repeated with an unknown, complex material. The mass of the unknown material is then correlated to the known material interpolating from the calibration curve. In this way, any hydrophobic particles may be used with any surface in which the particles homogeneously attach.

### Example 3: Glass or Plastic Spheres of Known Diameter

In a third example, glass or plastic spheres of known diameter are made hydrophobic using silicone polymer or the like, dried, and weighed. The unknown material is similarly made hydrophobic. The treated spheres are dispersed in water and the treated material is placed into the dispersion. The material is rinsed, dried, and weighed. The number of spheres collected on the material is calculated. Considering the packing factor and the number of spheres collected, the surface area is directly calculated without need for a calibration curve.

### Specific Embodiments

### Method for Measuring a Surface Area of Collection Media

In summary, and by way of example, the present invention may include, or take the form of, a method for measuring a surface area of collection media having a collection surface, including a collection surface having a complex surface like reticulated foam, e.g., including steps of:
1) rendering the collection surface hydrophobic,
2) contacting the collection surface with an aqueous mixture containing hydrophobic particles so as to achieve a single layer of the hydrophobic particles on the collection surface, and
3) determining the surface area based on the number or mass of the hydrophobic particles in the single layer.

The method may include one or more of the following:

The hydrophobic particles may include mineral particles.

The collection surface may include a foam, or a three-dimensional open-cell structure.

The method may include determining and comparing the mass of the collecting surface without the single layer and the mass of the collection surface with the single layer.

The method may include functionalizing the collection surface with poly(dimethylsiloxane), fluoroarylsilane.

The collection surface may be made of a hydrophobic material.

### Apparatus for Measuring a Surface Area of Collection Media

According to some embodiments, the present invention may include, or take the form of, apparatus for determining a surface area of collection media having a complex collection surface with a surface area, featuring a signal processor or processing module configured to:
receive signaling containing information about a weight of collection media having a complex collection surface with a surface area for attaching mineral particle of interest; and
determine corresponding signaling containing information about the surface area derived from a calibration table storing known relationships between known weights of known collection media having known complex collection surfaces with known surface areas, based upon the signaling received.

The apparatus may include one or more of the following features:

The collection media may include macroscopic objects that have a complex geometry and a macroscopic pore structure.

The macroscopic objects may be reticulated polymeric foam having the complex geometry and the macroscopic pore structure.

The weight determined is based upon a measurement related to a monolayer of hydrophobic particle adhering to the complex collection surface.

The weight determined is based upon a measurement related to a coating of a silicon polymer sprayed on the complex collection surface for attracting the mineral particle of interest.

The surface area determined is based upon measurements related to a monolayer of hydrophobic particle adhering to the known complex collection surfaces.

The surface area determined is based upon measurements related to a coating of a silicon polymer sprayed on the known complex collection surfaces for attracting the mineral particle of interest.

The apparatus comprises a memory or memory module configured to store the calibration table, e.g., that may be configured to respond to look-up signaling containing information about the weight of the collection media, and provide calibrated signaling containing information about the surface area of the collection media weighed.

The weight of the collection media having the complex collection surface with the surface area for attaching mineral particle of interest includes a coating weight of the coating of the silicon polymer sprayed on the complex collection surface for attracting the mineral particle of interest.

### BRIEF DESCRIPTION OF THE DRAWING

Referring now to the drawing, which are not necessarily drawn to scale, the foregoing and other features and advantages of the present invention will be more fully understood from the following detailed description of illustrative embodiments, taken in conjunction with the accompanying drawing in which like elements are numbered alike:

FIG. 1 is a graph of a concentrated mass pull versus foam surface area showing the mass pull (g) in relation to the surface area (m2/M3), according to some embodiments of the present invention.

FIG. 2A shows a picture of reticulated form with Cu mineral entrained throughout the structure.

FIG. 2B is a picture of loaded media after exposure to tailings slurry containing 0.04% Cu and 0.011% MoS₂.

FIG. 3A illustrates a mineral laden synthetic bead, or loaded bead.

FIG. 3B illustrates part of a loaded bead having molecules to attract mineral particles.

FIGS. 4A to 4E illustrate an engineered bead with different shapes and structures.

FIG. 5 is a block diagram of apparatus for implementing some embodiments according to the present invention.

FIG. 6 is a diagram of a flotation system, process or apparatus that forms part of a mineral processing system and uses collection media according to some embodiments of the present invention.

### DETAILED DESCRIPTION OF THE BEST MODE OF THE INVENTION

### Summary of the Present Invention

In summary, according to some embodiments, the present invention is directed toward a technique for determining the surface area of a hydrophobic collection surface by imparting a single layer of hydrophobic particles thereon and, based on the weight or mass of the hydrophobic particles in the single layer, calculating the surface area.

If the density and the size (volume, diameter) of the spherical hydrophobic particles are known, then the number of the hydrophobic particles in the single layer can be calculated from the mass of the hydrophobic particles in the single layer. The surface area of a collection surface can also be computed from the diameter and the number of the hydrophobic particles (e.g., see Example 3 above).

If the density of the hydrophobic particles are not known and the size of the particles is reasonably uniform (e.g., see Example 1, P80<certain size), and one would like to determine the surface area, S, of a collection surface made from a certain material (foam k), one can do the following:
Use at least one known surface area, S(r), of the material k as a reference sample to achieve a single layer of the hydrophobic particles;
Determine the mass or weight, W(r) of the hydrophobic particles in the single layer on the reference sample;
Obtain a surface-to-weight ratio M(r)=S(r)/W(r) of the reference sample;
Determine the mass, W(a), of the hydrophobic particles in the single layer on the surface area of the same material k of an unknown size;
Calculate the surface area S(a) based on W(a) and the surface-to-weight ratio M(r), or S(a)=W(a)×S(r)/W(r).

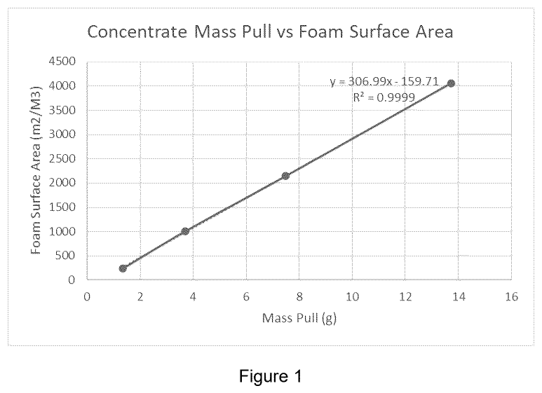

In Example 1, 100 half inch cubes of the same material k are used to determine the surface-to-weight ratio. Instead of determining the mass of the hydrophobic particles in the single layer on the cubes, the mass is calculated by comparing the weight of the cubes with a single layer of hydrophobic particles and the weight of the same cubes without the hydrophobic particles. The collection surfaces are rendered hydrophobic by a hydrophobic coating. The hydrophobic particles are chalcopyrite mineral particles reacting to potassium amyl xanthate in water. The graph in FIG. 1 is used to show the consistency of M(k), with an R-squared of 0.9999, e.g., that may include data corresponding to the data stored in a calibration table.

Example 1 shows that the mass of the hydrophobic particles in the single layer on a collection surface can be determined by comparing the weight of the particle-laden collection surface to the weight of the bare collection surface.

By way of example, the collection surface in Example 1 and Example 3 can be rendered hydrophobic by a coating of hydrophobic material such as polysiloxane, fluoroaryl silane, fluoroarkyl silane, or the like.

By way of example, the particles used in Example 3 can be beads made of glass or plastic of known density and rendered hydrophobic by a coating of hydrophobic material such as polysiloxane, fluoroaryl silane, fluoroarkyl silane, or the like (one dependent claim)

Further, Example 1 shows a way to measure the surface area of a collection surface of a certain material using hydrophobic particles of unknown density. Using a collection surface of the same material of a known size as a reference sample to determine the surface-to-weight ratio for that particular material. Based on the weight of the hydrophobic particles in the single layer, determine the surface area of the collection surface made of an unknown size using the surface-to-weight ratio.

Thus, if hydrophobic particles of known size and density are available, they can be used to determine the surface area of any hydrophobic materials. If the density and size of hydrophobic particles are unknown, the hydrophobic particles can still be used to determine the surface area of a hydrophobic material based on the surface-to-weight ratio of the same hydrophobic material and same hydrophobic particles.

By way of further example, Example 3 shows a way to measure the surface area of a collection surface of an unknown material using hydrophobic particles of known density and known size. Based on the weight or mass of the hydrophobic particles in the single layer, determine the number of hydrophobic particles in the single layer using the density and size of the particles. Based on the number and the size of the particles, determine the surface area of the collection surface.

### Example 1

By way of further example, steps for implementing the Example 1 described above in relation to determining information about the collection media and/or known collection media may include the following:
rendering chalcopyrite mineral hydrophobic via reaction with potassium amyl xanthate to form hydrophobic chalcopyrite mineral;
dispensing the hydrophobic chalcopyrite mineral in water to form a mineral dispersion;
coating the collection media with a hydrophobic coating to form hydrophobic collection media;
weighing the hydrophobic collection media to determining a hydrophobic collection media weight;
adding the hydrophobic collection media to the mineral dispersion;
agitating the mineral dispersion to form mineral-laden collection media;
removing the mineral-laden collection media from the mineral dispersion;
placing the mineral-laden collection media in water to remove any non-attached mineral particle of interest;
removing the mineral-laden collection media from the water;
draining the water from the mineral-laden collection media to form drained mineral-laden collection media;
drying the drained mineral-laden collection media to form dried and drained mineral-laden collection media;
weighing the dried and drained mineral-laden collection media to determine a mineral-laden collection media weight of the dried and drained mineral-laden collection media; and
determining an amount of the mineral particle of interest attached to the complex collection surface and forming part of the monolayer layer, based upon a weight difference between the hydrophobic collection media weight and the mineral-laden collection media weight.

As one skilled in the art would appreciate, steps for implementing the Examples 2 and 3 described above in relation to determining information about the collection media and/or known collection media may include similar steps, along with additional steps consistent with that described above.

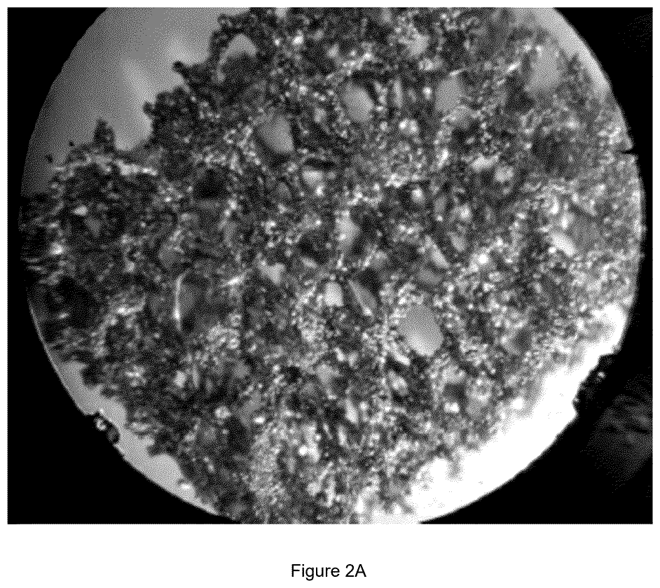

### FIGS. 2A and 2B

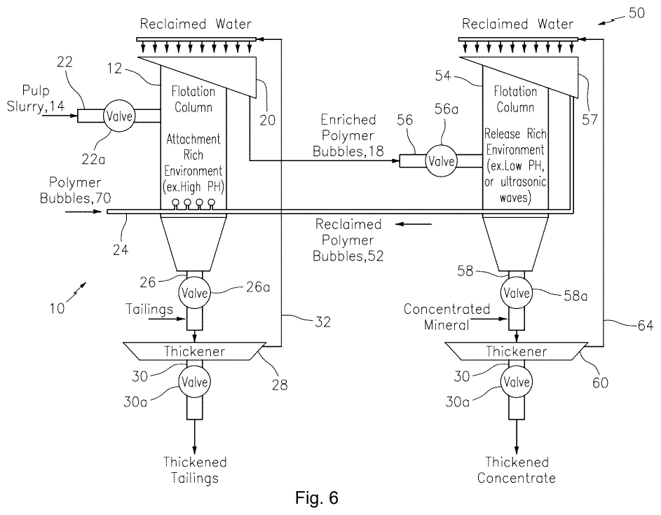

By way of example, FIGS. 2A and 2B show examples of engineered or collection media according to some embodiments of the present invention, e.g., that may be used in, or form part of, a system or apparatus like that shown in FIG. 6 for separating valuable material from unwanted material in a mixture, e.g., consistent with that disclosed in the aforementioned applications and patents assigned to the assignee of the instant application and incorporated by reference herein, including PCT application no. PCT/US16/62242 (Atty docket no. 712-002.426-1/CCS-0154).

In particular, FIG. 2A shows an example of a section of polymer coated reticulated foam used for recovery of Chalcopyrite, wherein mineral particles captured copper ore slurry can be seen throughout the foam network.

Open-cell foam and sponge-like material can be as engineered collection media. Open cell or reticulated foam offers an advantage over other media shapes such as the sphere by having higher surface area to volume ratio. Applying a functionalized polymer coating that promotes attachment of mineral to the foam “network” enables higher recovery rates and improved recovery of less liberated mineral when compared to the conventional process. For example, open cells allow passage of fluid and particles smaller than the cell size but capture mineral bearing particles the come in contact with the functionalized polymer coating. Selection of cell size is dependent upon slurry properties and application.

As mentioned earlier, the open cell or reticulated foam, when coated or soaked with hydrophobic chemical, offers an advantage over other media shapes such as sphere by having higher surface area to volume ratio. Surface area is an important property in the mineral recovery process because it defines the amount of mass that can be captured and recovered. High surface area to volume ratios allows higher recovery per unit volume of media added to a cell.

The open cell or reticulated foam provides functionalized three dimensional open network structures having high surface area with extensive interior surfaces and tortuous paths protected from abrasion and premature release of attached mineral particles. This provides for enhanced collection and increased functional durability. Spherical shaped recovery media, such as beads and foam, can have poor surface area to volume ratio—these media do not provide high surface area for maximum collection of minerals. Furthermore, certain media such as beads and foam may be subject to rapid degradation of functionality.

Applying a functionalized polymer coating that promotes attachment of mineral to the foam “network” enables higher recovery rates and improved recovery of less liberated mineral when compared to the conventional process. This foam is open cell so it allows passage of fluid and particles smaller than the cell size but captures mineral bearing particles the come in contact with the functionalized polymer coating. Selection of cell size is dependent upon slurry properties and application.

A three-dimensional open cellular structure optimized to provide a compliant, tacky surface of low energy enhances collection of hydrophobic or hydrophobized mineral particles ranging widely in particle size. This structure may be comprised of open-cell foam coated with a compliant, tacky polymer of low surface energy. The foam may be comprised of reticulated polyurethane or another appropriate open-cell foam material such as silicone, polychloroprene, polyisocyanurate, polystyrene, polyolefin, polyvinylchloride, epoxy, latex, fluoropolymer, phenolic, EPDM, nitrile, composite foams and such. The coating may be a polysiloxane derivative such as polydimethylsiloxane and may be modified with tackifiers, plasticizers, crosslinking agents, chain transfer agents, chain extenders, adhesion promoters, aryl or alky copolymers, fluorinated copolymers, hydrophobizing agents such as hexamethyldisilazane, and/or inorganic particles such as silica or hydrophobic silica. Alternatively, the coating may be comprised of materials typically known as pressure sensitive adhesives, e.g., acrylics, butyl rubber, ethylene vinyl acetate, natural rubber, nitriles; styrene block copolymers with ethylene, propylene, and isoprene; polyurethanes, and polyvinyl ethers as long as they are formulated to be compliant and tacky with low surface energy.

The three-dimensional open cellular structure may be coated with a primer or other adhesion agent to promote adhesion of the outer collection coating to the underlying structure.

In addition to soft polymeric foams, other three-dimensional open cellular structures such as hard plastics, ceramics, carbon fiber, and metals may be used. Examples include Incofoam®, Duocel®, metal and ceramic foams produced by American Elements®, and porous hard plastics such as polypropylene honeycombs and such. These structures must be similarly optimized to provide a compliant, tacky surface of low energy by coating as above.

The three-dimensional, open cellular structures above may be coated or may be directly reacted to form a compliant, tacky surface of low energy.

The three-dimensional, open cellular structure may itself form a compliant, tacky surface of low energy by, for example, forming such a structure directly from the coating polymers as described above. This is accomplished through methods of forming open-cell polymeric foams known to the art.

The structure may be in the form of sheets, cubes, spheres, or other shapes as well as densities (described by pores per inch and pore size distribution), and levels of tortuosity that optimize surface access, surface area, mineral attachment/detachment kinetics, and durability. These structures may be additionally optimized to target certain mineral particle size ranges, with denser structures acquiring smaller particle sizes. In general, cellular densities may range from 10-200 pores per inch, more preferably 30-90 pores per inch, and most preferably 30-60 pores per inch.

The specific shape or form of the structure may be selected for optimum performance for a specific application. For example, the structure (coated foam for example) may be cut in a variety of shapes and forms. For example, strips, blocks, and/or sheets of coated foam of varying size could also be used where they are randomly mixed along with the slurry in a mixing cell. Alternatively, the polymer coated reticulated foam may be used to recover Chalcopyrite mineral. Mineral particles captured from copper ore slurry can be seen throughout the foam network.

FIG. 2B shows an example of loaded engineered or collection media in the form of a synthetic bead exposed to a tailings slurry containing 0.04% Cu and 0.011% MoS₂. As shown in FIG. 2B, each of the two loaded synthetic beads 170 has many specks of mineral particles 172 attached to a bead surface 174 of the engineered or collection media or bead (synthetic bead) 170.

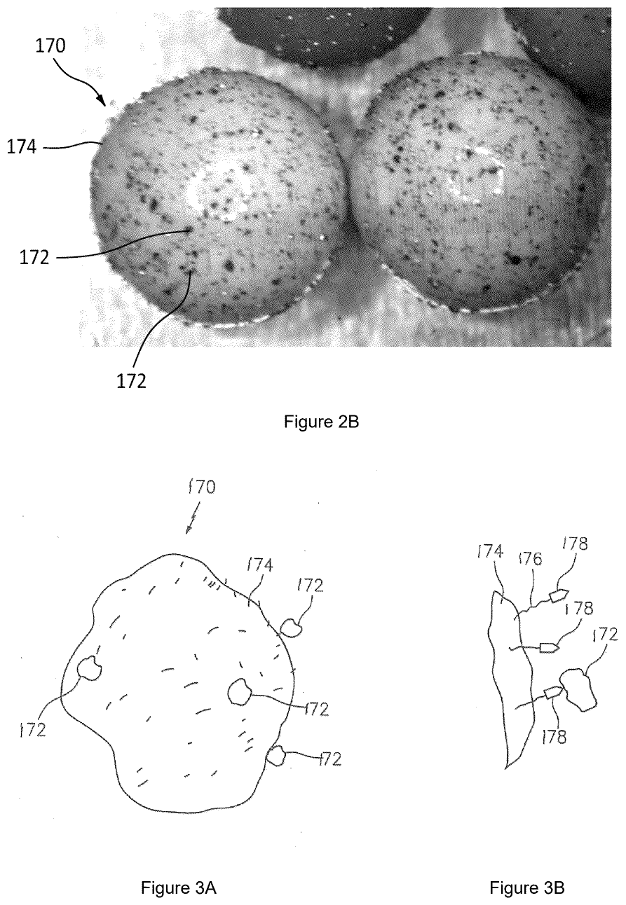

### FIGS. 3A and 3B

By way of example, FIGS. 3A and 3B show examples of engineered or collection media according to some embodiments of the present invention, e.g., that may be used in, or form part of, a system or apparatus like that shown in FIG. 1 for separating valuable material from unwanted material in a mixture, e.g., consistent with that disclosed in the aforementioned applications and patents assigned to the assignee of the instant application and incorporated by reference herein, including PCT application no. PCT/US2017/059491 (Atty docket no. 712-002.440-1/CCS-0176), corresponding to U.S. Pat. No. 11,247,212.

In particular, FIG. 3A illustrates the engineered or collection media in the form of a mineral laden synthetic bead, or loaded bead 170. As illustrated, the synthetic bead 170 can attract many mineral particles 172. FIG. 3B illustrates part of a loaded bead having a bead surface 174 with molecules (176, 178) to attract the mineral particles 172.

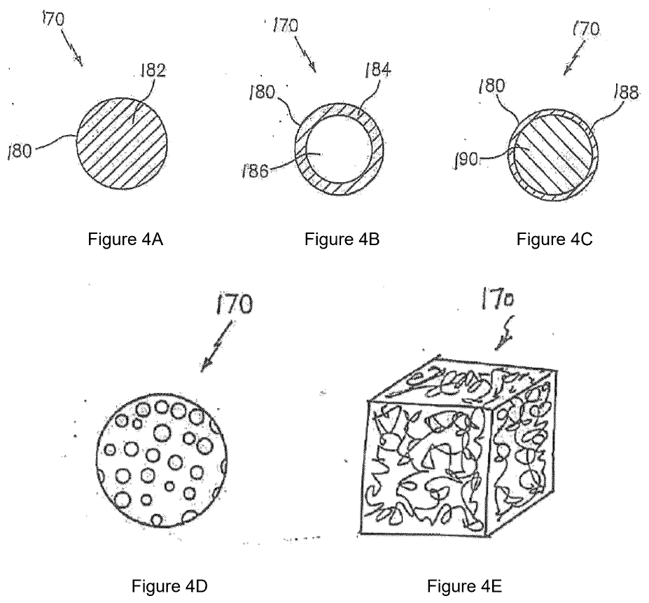

As shown in FIGS. 3A and 3B, the synthetic bead 170 has a bead body (e.g., see FIGS. 4A-4E re element 180) to provide a bead surface 174. At least the outside part of the bead body is made of a synthetic material, such as polymer, so as to provide a plurality of molecules or molecular segments 176 on the bead surface 174. The molecule 176 is used to attach a chemical functional group 178 to the bead surface 174. In general, the molecule 176 can be a hydrocarbon chain, for example, and the functional group 178 can have an anionic bond for attracting or attaching a mineral, such as copper to the bead surface 174. A xanthate, for example, has both the functional group 178 and the molecular segment 176 to be incorporated into the polymer that is used to make the synthetic bead 170. A functional group 178 is also known as a collector that is either ionic or non-ionic. The ion can be anionic or cationic. An anion includes oxyhydryl, such as carboxylic, sulfates and sulfonates, and sulfhydral, such as xanthates and dithiophosphates. Other molecules or compounds that can be used to provide the function group 178 include, but are not limited to, thionocarboamates, thioureas, xanthogens, monothiophosphates, hydroquinones and polyamines. Similarly, a chelating agent can be incorporated into or onto the polymer as a collector site for attracting a mineral, such. As shown in FIG. 7b, a mineral particle 172 is attached to the functional group 178 on a molecule 176. In general, the mineral particle 172 is much smaller than the synthetic bead 170. Many mineral particles 172 can be attracted to or attached to the bead surface 174 of the synthetic bead 170.

### FIGS. 4A to 4E

By way of example, FIGS. 4A to 4E show examples of engineered or collection media according to some embodiments of the present invention, e.g., that may be used in, or form part of, a system or apparatus for separating valuable material from unwanted material in a mixture, e.g., consistent with that disclosed in the aforementioned applications and patents assigned to the assignee of the instant application and incorporated by reference herein, including the aforementioned PCT application no. PCT/US2017/059491 (Atty docket no. 712-002.440-1/CCS-0176).

In particular, the synthetic bead may be configured as a solid-phase body made of a synthetic material, such as polymer. The polymer can be rigid or elastomeric. An elastomeric polymer can be polyisoprene or polybutadiene, for example. The synthetic bead 170 has a bead body 180 having a bead surface (see FIGS. 3A and 3B re element 174) comprising a plurality of molecules with one or more functional groups for attracting mineral particles to the surface. A polymer having a functional group to collect mineral particles is referred to as a functionalized polymer. In one embodiment, the entire interior part 182 of the synthetic bead 170 is made of the same functionalized material, as shown in FIG. 4A. In another embodiment, the bead body 180 comprises a shell 184. The shell 184 can be formed by way of expansion, such as thermal expansion or pressure reduction. The shell 184 can be a micro-bubble or a balloon. In FIG. 4B, the shell 184, which is made of functionalized material, has an interior part 186. The interior part 186 can be filled with air or gas to aid buoyancy, for example. The interior part 186 can be used to contain a liquid to be released during the mineral separation process. The encapsulated liquid can be a polar liquid or a non-polar liquid, for example. The encapsulated liquid can contain a depressant composition for the enhanced separation of copper, nickel, zinc, lead in sulfide ores in the flotation stage, for example. The shell 184 can be used to encapsulate a powder which can have a magnetic property so as to cause the synthetic bead to be magnetic, for example. The encapsulated liquid or powder may contain monomers, oligomers or short polymer segments for wetting the surface of mineral particles when released from the beads. For example, each of the monomers or oligomers may contain one functional group for attaching to a mineral particle and an ion for attaching the wetted mineral particle to the synthetic bead. The shell 84 can be used to encapsulate a solid core, such as Styrofoam to aid buoyancy, for example. In yet another embodiment, only the coating of the bead body is made of functionalized polymer. As shown in FIG. 4C, the synthetic bead has a core 190 made of ceramic, glass or metal and only the surface of core 190 has a coating 188 made of functionalized polymer. The core 190 can be a hollow core or a filled core depending on the application. The core 190 can be a micro-bubble, a sphere or balloon. A core 190 made of glass or ceramic can be used to make the density of the synthetic bead substantially equal to the density of the pulp slurry so that when the synthetic beads are mixed into the pulp slurry for mineral collection, the beads can be in a suspension state.

The synthetic bead 170 can be a porous block or take the form of a sponge or foam with multiple segregated gas filled chambers, e.g., as shown in FIGS. 4D and 4E.

It should be understood that the term “bead” does not limit the shape of the synthetic bead of the present invention to be spherical. In some embodiments of the present invention, the synthetic bead 170 can have an elliptical shape, a cylindrical shape, or a shape of a block. Furthermore, the synthetic bead can have an irregular shape.

It should also be noted that the synthetic beads of the present invention can be realized by a different way to achieve the same goal. Namely, it is possible to use a different means to attract the mineral particles to the surface of the synthetic beads. For example, the surface of the polymer beads or shells can be functionalized with a hydrophobic chemical molecule or compound. The synthetic beads and/or engineered collection media can be made of a polymer. The term “polymer” in this specification means a large molecule made of many units of the same or similar structure linked together. Furthermore, the polymer can be naturally hydrophobic or functionalized to be hydrophobic. Some polymers having a long hydrocarbon chain or silicon-oxygen backbone, for example, tend to be hydrophobic. Hydrophobic polymers include polystyrene, poly(d,l-lactide), poly(dimethylsiloxane), polypropylene, polyacrylic, polyethylene, etc. The bubbles/beads, such as synthetic bead 170 can be made of glass to be coated with hydrophobic silicone polymer including polysiloxanates so that the bubbles/beads become hydrophobic. The bubbles/beads can be made of metal to be coated with silicone alkyd copolymer, for example, so as to render the bubbles/beads hydrophobic. The bubbles/beads can be made of ceramic to be coated with fluoroalkylsilane, for example, so as to render the bubbles/beads hydrophobic. The bubbles/beads can be made of hydrophobic polymers, such as polystyrene and polypropylene to provide a hydrophobic surface. The wetted mineral particles attached to the hydrophobic synthetic bubble/beads can be released thermally, ultrasonically, electromagnetically, mechanically or in a low pH environment.

The multiplicity of hollow objects, bodies, elements or structures may include hollow cylinders or spheres, as well as capillary tubes, or some combination thereof. The scope of the invention is not intended to be limited to the type, kind or geometric shape of the hollow object, body, element or structure or the uniformity of the mixture of the same.

One disadvantage of spherical shaped recovery media such as a bubble, is that it possesses a poor surface area to volume ratio. Surface area is an important property in the mineral recovery process because it defines the amount of mass that can be captured and recovered. High surface area to volume ratios allows higher recovery per unit volume of media added to a cell. As illustrated in FIG. 4E, open-cell foam and sponge-like material can be as engineered collection media. Open cell or reticulated foam offers an advantage over other media shapes such as the sphere by having higher surface area to volume ratio. Applying a functionalized polymer coating that promotes attachment of mineral to the foam “network” enables higher recovery rates and improved recovery of less liberated mineral when compared to the conventional process. For example, open cells allow passage of fluid and particles smaller than the cell size but capture mineral bearing particles the come in contact with the functionalized polymer coating. Selection of cell size is dependent upon slurry properties and application.

The coated foam may be cut in a variety of shapes and forms. For example, strips, blocks, and/or sheets of coated foam of varying size can also be used where they are randomly mixed along with the slurry in a mixing cell.

As mentioned earlier, the open cell or reticulated foam, when coated or soaked with hydrophobic chemical, offers an advantage over other media shapes such as sphere by having higher surface area to volume ratio. Surface area is an important property in the mineral recovery process because it defines the amount of mass that can be captured and recovered. High surface area to volume ratios allows higher recovery per unit volume of media added to a cell.

The open cell or reticulated foam provides functionalized three dimensional open network structures having high surface area with extensive interior surfaces and tortuous paths protected from abrasion and premature release of attached minerals particles. This provides for enhanced collection and increased functional durability. Spherical shaped recovery media, such as beads, can have poor surface area to volume ratio—these media do not provide high surface area for maximum collection of minerals. Furthermore, certain media such as beads, may be subject to rapid degradation of functionality.

Applying a functionalized polymer coating that promotes attachment of minerals to the foam “network” enables higher recovery rates and improved recovery of less liberated minerals when compared to the conventional process. This foam is open cell so it allows passage of fluid and particles smaller than the cell size but captures mineral bearing particles the come in contact with the functionalized polymer coating. Selection of cell size is dependent upon slurry properties and application.

A three-dimensional open cellular structure optimized to provide a compliant, tacky surface of low energy enhances collection of hydrophobic or hydrophobized mineral particles ranging widely in particle size. This structure may be comprised of open-cell foam coated with a compliant, tacky polymer of low surface energy. The foam may be comprised of reticulated polyurethane or another appropriate open-cell foam material such as silicone, polychloroprene, polyisocyanurate, polystyrene, polyolefin, polyvinylchloride, epoxy, latex, fluoropolymer, phenolic, EPDM, nitrile, composite foams and such. The coating may be a polysiloxane derivative such as polydimethylsiloxane and may be modified with tackifiers, plasticizers, crosslinking agents, chain transfer agents, chain extenders, adhesion promoters, aryl or alky copolymers, fluorinated copolymers, hydrophobizing agents such as hexamethyldisilazane, and/or inorganic particles such as silica or hydrophobic silica. Alternatively, the coating may be comprised of materials typically known as pressure sensitive adhesives, e.g., acrylics, butyl rubber, ethylene vinyl acetate, natural rubber, nitriles; styrene block copolymers with ethylene, propylene, and isoprene; polyurethanes, and polyvinyl ethers as long as they are formulated to be compliant and tacky with low surface energy.

The three-dimensional open cellular structure may be coated with a primer or other adhesion agent to promote adhesion of the outer collection coating to the underlying structure.

In addition to soft polymeric foams, other three-dimensional open cellular structures such as hard plastics, ceramics, carbon fiber, and metals may be used. Examples include Incofoam®, Duocel®, metal and ceramic foams produced by American Elements®, and porous hard plastics such as polypropylene honeycombs and such. These structures must be similarly optimized to provide a compliant, tacky surface of low energy by coating as above.

The three-dimensional, open cellular structures above may be coated or may be directly reacted to form a compliant, tacky surface of low energy.

The three-dimensional, open cellular structure may itself form a compliant, tacky surface of low energy by, for example, forming such a structure directly from the coating polymers as described above. This is accomplished through methods of forming open-cell polymeric foams known to the art.

The structure may be in the form of sheets, cubes, spheres, or other shapes as well as densities (described by pores per inch and pore size distribution), and levels of tortuosity that optimize surface access, surface area, mineral attachment/detachment kinetics, and durability. These structures may be additionally optimized to target certain mineral particle size ranges, with denser structures acquiring smaller particle sizes. In general, cellular densities may range from 10-200 pores per inch, more preferably 30-90 pores per inch, and most preferably 30-60 pores per inch.

The specific shape or form of the structure may be selected for optimum performance for a specific application. For example, the structure (coated foam for example) may be cut in a variety of shapes and forms. For example, strips, blocks, and/or sheets of coated foam of varying size could also be used where they are randomly mixed along with the slurry in a mixing cell.

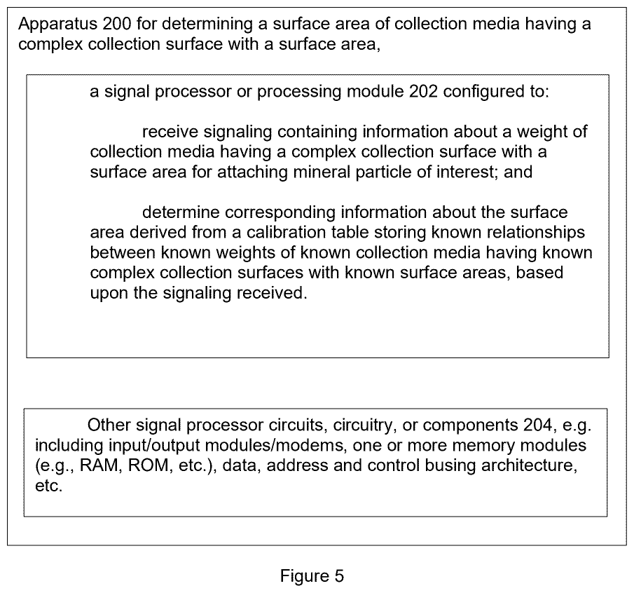

### FIG. 5: The Apparatus

By way of example, FIG. 5 shows apparatus 200 for determining a surface area of collection media having a complex collection surface with a surface area, e.g., according to some embodiments of the present invention. The apparatus includes a signal processor or processing module 202 and other signal processor circuits, circuitry, or components 204.

The signal processor or processing module 202 may be configured to
receive signaling containing information about a weight of collection media having a complex collection surface with a surface area for attaching mineral particle of interest; and
determine corresponding signaling containing information about the surface area derived from a calibration table storing known relationships between known weights of known collection media having known complex collection surfaces with known surface areas, based upon the signaling received.

The other signal processor circuits, circuitry, or components 204 may include input/output modules/modems, one or more memory modules (e.g., RAM, ROM, etc.), data, address and control busing architecture, etc.

The functionality of the signal processor or processing module 202 can be implemented using hardware, software, firmware, or a combination thereof. In a typical software implementation, the module 202 would include one or more microprocessor-based architectures having, e. g., at least one signal processor or microprocessor. A person skilled in the art would be able to program such a microcontroller (or microprocessor)-based implementation to perform the functionality described herein without undue experimentation. The scope of the invention is not intended to be limited to any particular implementation using technology either now known or later developed in the future. The scope of the invention is intended to include implementing the functionality of the processors as stand-alone processor or processor module, as separate processor or processor modules, as well as some combination thereof.

The other signal processor circuits or components 204, e.g., may include one or more memory modules like random access memory (RAM) and/or read only memory (ROM), input/output devices and control, and data and address buses connecting the same, and/or at least one input processor and at least one output processor. By way of example, the memory module may be configured to store the calibration table, consistent with that set forth herein. Moreover, the memory or memory module may be configured to respond to look-up signaling containing information about the weight of the collection media, and provide calibrated signaling containing information about the surface area of the collection media weighed.

The signal processor or processing module may be configured to receive the signaling containing information about a weight of collection media having a complex collection surface with a surface area for attaching mineral particle of interest, e.g., via an input from a user, signaling provided by a scale or other weighting device, etc. The scope of the invention is not intended to be limited to any particular type or way of receiving the signaling, e.g., either now known or later developed in the future.

The signal processor or processing module may be configured to build the calibration table by receiving and/or providing known collection media signaling containing information about the known relationships between known weights of known collection media having known complex collection surfaces with known surface areas for storing in the calibration table. Embodiments are envisioned, and the scope of the invention is intended to include, the calibration table being built by some other device and the signal processor or processing module having access to the calibration table. The scope of the invention is not intended to be limited to any particular type or way of building the calibration table, or how the signal processor or processing module gains access to the calibration table, e.g., either now known or later developed in the future.

The signal processor or processing module may be configured to provide the look-up signaling to the memory or memory module storing the calibration table, and receive the calibrated signaling containing information about the surface area of the collection media weighed for further processing. By way of example, the further processing may include providing display signaling for displaying the calibrated signaling containing information about the surface area of the collection media weighed, e.g., on a display, or for providing an audio signal for announcing the calibrated signaling containing information about the surface area of the collection media weighed, e.g., via a speaker. The scope of the invention is not intended to be limited to any particular type or kind of further processing, e.g., either now known or later developed in the future.

### FIG. 6

By way of example, FIG. 6 show an examples of a system or apparatus for separating valuable material from unwanted material in a mixture, e.g., that may use engineered or collection media according to the present invention set forth herein, and consistent with that disclosed in the aforementioned applications and patents assigned to the assignee of the instant application and incorporated by reference herein, including PCT application no. PCT/US2013/034762 (Atty docket no. 712-002.379-1/CCS-0083) that corresponds to U.S. Pat. No. 10,245,597.

In particular, FIG. 6 shows apparatus 10, having a flotation cell or column 12 configured to receive a mixture of fluid (e.g. water), valuable material and unwanted material, e.g., a pulp slurry 14; receive synthetic bubbles/beads 70 (e.g., see also FIGS. 2B, 3A to FIG. 4E re element 170) that are constructed to be buoyant when submerged in the pulp slurry or mixture 14 and functionalized to control the chemistry of a process being performed in the flotation cell or column, including to attach to the valuable material in the pulp slurry or mixture 14; and provide enriched synthetic bubble/beads 18 having the valuable material attached thereon. The synthetic bubbles/beads like 18, 52, 70 may be formed as engineered or collection media, e.g., according to some embodiments of the present invention.

The terms “synthetic bubbles/beads” and “polymer bubbles/beads” are used interchangeably in this disclosure. The terms “valuable material”, “valuable mineral” and “mineral particle” are also used interchangeably. By way of example, the synthetic bubbles/beads like 18, 52, 70 may be made from polymer or polymer-based materials, or silica or silica-based materials, or glass or glass-based materials, although the scope of the invention is intended to include other types or kinds of material either now known or later developed in the future. For the purpose of describing one example of the present invention, in FIG. 6 the synthetic bubbles/beads 70 (e.g., see also FIGS. 2B, 3A thru 4E re element 170) are also shown and labeled as the enriched synthetic bubble or beads 18 and the reclaimed bubble/beads 52. The flotation cell or column 12 is configured with a top portion or piping 20 to provide the enriched polymer or polymer-based bubbles/beads 18 from the flotation cell or column 12 for further processing consistent with that set forth herein.

The flotation cell or column 12 may be configured with a top part or piping 22, e.g., having a valve 22a, to receive the pulp slurry or mixture 14 and also with a bottom part or piping 24 to receive the synthetic bubbles/beads 70. In operation, the buoyancy of the synthetic bubbles/beads 70 causes them to float upwardly from the bottom to the top of the flotation cell or column 12 through the pulp slurry or mixture 14 in the flotation cell or column 12 so as to collide with the water, valuable material and unwanted material in the pulp slurry or mixture 14. The functionalization of the synthetic bubbles/beads 70 causes them to attach to the valuable material in the pulp slurry or mixture 14. As used herein, the term “functionalization” means that the properties of the material making up the synthetic bubbles/beads 70 are either selected (based upon material selection) or modified during manufacture and fabrication, to be “attracted” to the valuable material, so that a bond is formed between the synthetic bubbles/beads 70 and the valuable material, so that the valuable material is lifted through the cell or column 12 due to the buoyancy of the synthetic bubbles/beads 70. For example, the surface of synthetic bubbles/beads has functional groups for collecting the valuable material. Alternatively, the synthetic bubbles/beads are functionalized to be hydrophobic for attracting wetted mineral particles—those mineral particles having collector molecules attached thereto. As a result of the collision between the synthetic bubbles/beads 70 and the water, valuable material and unwanted material in the pulp slurry or mixture 14, and the attachment of the synthetic bubbles/beads 70 and the valuable material in the pulp slurry or mixture 14, the enriched polymer or polymer-based bubbles 18 having the valuable material attached thereto will float to the top of the flotation cell 12 and form part of the froth formed at the top of the flotation cell 12. The flotation cell 12 may include the top part or piping 20 configured to provide the enriched polymer or polymer-based bubbles 18 having the valuable material attached thereto, which may be further processed consistent with that set forth herein. In effect, the enriched polymer or polymer-based bubbles 18 may be taken off the top of the flotation cell 12 or may be drained off by the top part or piping 20.

The flotation cell or column 12 may be configured to contain an attachment rich environment, including where the attachment rich environment has a high pH, so as to encourage the flotation recovery process therein. The flotation recovery process may include the recovery of ore particles in mining, including copper. The scope of the invention is not intended to be limited to any particular type or kind of flotation recovery process either now known or later developed in the future. The scope of the invention is also not intended to be limited to any particular type or kind of mineral of interest that may form part of the flotation recovery process either now known or later developed in the future.

The synthetic bubbles/beads 70 may be configured with a surface area flux by controlling some combination of the size of the polymer or polymer-based bubbles and/or the injection rate that the pulp slurry or mixture 14 is received in the flotation cell or column 12. The synthetic bubbles/beads 70 may also be configured with a low density so as to behave like air bubbles. The synthetic bubbles/beads 70 may also be configured with a controlled size distribution of medium that may be customized to maximize recovery of different feed matrixes to flotation as valuable material quality changes, including as ore quality changes.

The flotation cell or column 12 may be configured to receive the synthetic bubbles/beads 70 together with air, where the air is used to create a desired froth layer in the mixture in the flotation cell or column 12 in order to achieve a desired grade of valuable material. The synthetic bubbles/beads 70 may be configured to lift the valuable material to the surface of the mixture in the flotation cell or column.

### The Thickener 28

The apparatus 10 may also include piping 26 having a valve 26a for providing tailings to a thickener 28 configured to receive the tailings from the flotation cell or column 12. The thickener 28 includes piping 30 having a valve 30a to provide thickened tailings. The thickener 28 also includes suitable piping 32 for providing reclaimed water back to the flotation cell or column 12 for reuse in the process. Thickeners like element 28 are known in the art, and the scope of the invention is not intended to be limited to any particular type or kind either now known or later developed in the future.

### The Bead Recovery Process or Processor 50

The apparatus 10 may further comprises a bead recovery process or processor generally indicated as 50 configured to receive the enriched polymer or polymer-based bubbles/beads 18 and provide reclaimed polymer or polymer-based bubbles/beads 52 without the valuable material attached thereon so as to enable the reuse of the polymer or polymer-based bubbles/beads 52 in a closed loop process. By way of example, the bead recovery process or processor 50 may take the form of a washing station whereby the valuable mineral is mechanically, chemically, or electro-statically removed from the polymer or polymer-based bubbles/beads 18.

The bead recovery process or processor 50 may include a releasing apparatus in the form of a second flotation cell or column 54 having piping 56 with a valve 56a configured to receive the enriched polymer bubbles/beads 18; and substantially release the valuable material from the polymer bubbles/beads 18, and also having a top part or piping 57 configured to provide the reclaimed polymer bubbles/beads 52, substantially without the valuable material attached thereon The second flotation cell or column 54 may be configured to contain a release rich environment, including where the release rich environment has a low pH, or including where the release rich environment results from ultrasonic waves pulsed into the second flotation cell or column 54.

The bead recovery process or processor 50 may also include piping 58 having a valve 56a for providing concentrated minerals to a thickener 60 configured to receive the concentrated minerals from the flotation cell or column 54. The thickener 60 includes piping 62 having a valve 62a to provide thickened concentrate. The thickener 60 also includes suitable piping 64 for providing reclaimed water back to the second flotation cell or column 54 for reuse in the process. Thickeners like element 60 are known in the art, and the scope of the invention is not intended to be limited to any particular type or kind either now known or later developed in the future.

Embodiments are also envisioned in which the enriched synthetic beads or bubbles are placed in a chemical solution so the valuable material is dissolved off, or are sent to a smelter where the valuable material is burned off, including where the synthetic beads or bubbles are reused afterwards.

### Dosage Control

The synthetic beads or bubbles 70 may be functionalized to control the chemistry of the process being performed in the cell or column, e.g., to release a chemical to control the chemistry of the flotation separation process.

In particular, the flotation cell or column 12 in FIG. 6 may be configured to receive polymer-based blocks like synthetic beads containing one or more chemicals used in a flotation separation of the valuable material, including mining ores, that are encapsulated into polymers to provide a slow or targeted release of the chemical once released into the flotation cell or column 12. By way of example, the one or more chemicals may include chemical mixes both now known and later developed in the future, including typical frothers, collectors and other additives used in flotation separation. The scope of the invention is not intended to be limited to the type or kind of chemicals or chemical mixes that may be released into the flotation cell or column 12 using the synthetic bubbles according to the present invention.

The scope of the invention is intended to include other types or kinds of functionalization of the synthetic beads/bubbles 70 in order to provide other types or kinds of control of the chemistry of the process being performed in the cell or column, including either functionalizations and controls both now known and later developed in the future. For example, the synthetic beads or bubbles may be functionalized to control the pH of the mixture that forms part of the flotation separation process being performed in the flotation cell or column.

### Applications

In the mining industry, it is useful to determine the efficiency of mineral particle collection by a collection surface when a hydrophobic collection surface is used to separate valuable material from the unwanted material in a pulp slurry. For example, changing the surface topography could change the amount of mineral particles that can attach to the surface. When a surface has various surface features such as unevenness and complex structure, measurement of surface area would become difficult. Using the single-layer particle attachment method, according to the present invention, could help optimize the design of the collection surface for attracting hydrophobic minerals.

### The Related Family

This application is also related to a family of nine PCT applications, which were all concurrently filed on 25 May 2012, as follows:
PCT application no. PCT/US12/39528 (Atty docket no. 712-002.356-1), entitled “Flotation separation using lightweight synthetic bubbles and beads;”
PCT application no. PCT/US12/39524 (Atty docket no. 712-002.359-1), entitled “Mineral separation using functionalized polymer membranes;”
PCT application no. PCT/US12/39540 (Atty docket no. 712-002.359-2), entitled “Mineral separation using sized, weighted and magnetized beads;”
PCT application no. PCT/US12/39576 (Atty docket no. 712-002.382), entitled “Synthetic bubbles/beads functionalized with molecules for attracting or attaching to mineral particles of interest,” which corresponds to U.S. Pat. No. 9,352,335;
PCT application no. PCT/US12/39591 (Atty docket no. 712-002.383), entitled “Method and system for releasing mineral from synthetic bubbles and beads;”
PCT application no. PCT/US/39596 (Atty docket no. 712-002.384), entitled “Synthetic bubbles and beads having hydrophobic surface;”
PCT application no. PCT/US/39631 (Atty docket no. 712-002.385), entitled “Mineral separation using functionalized filters and membranes,” which corresponds to U.S. Pat. No. 9,302,270;”
PCT application no. PCT/US12/39655 (Atty docket no. 712-002.386), entitled “Mineral recovery in tailings using functionalized polymers;” and
PCT application no. PCT/US12/39658 (Atty docket no. 712-002.387), entitled “Techniques for transporting synthetic beads or bubbles in a flotation cell or column,” all of which are incorporated by reference in their entirety.

This application also related to PCT application no. PCT/US2013/042202 (Atty docket no. 712-002.389-1/CCS-0086), filed 22 May 2013, entitled “Charged engineered polymer beads/bubbles functionalized with molecules for attracting and attaching to mineral particles of interest for flotation separation,” which claims the benefit of U.S. Provisional Patent Application No. 61/650,210, filed 22 May 2012, which is incorporated by reference herein in its entirety.

This application is also related to PCT/US2014/037823, filed 13 May 2014, entitled “Polymer surfaces having a siloxane functional group,” which claims benefit to U.S. Provisional Patent Application No. 61/822,679 (Atty docket no. 712-002.395/CCS-0123), filed 13 May 2013, as well as U.S. patent application Ser. No. 14/118,984 (Atty docket no. 712-002.385/CCS-0092), filed 27 Jan. 2014, and is a continuation-in-part to PCT application no. PCT/US12/39631 (712-2.385//CCS-0092), filed 25 May 2012, which are all hereby incorporated by reference in their entirety.

This application also related to PCT application no. PCT/US13/28303 (Atty docket no. 712-002.377-1/CCS-0081/82), filed 28 Feb. 2013, entitled “Method and system for flotation separation in a magnetically controllable and steerable foam,” which is also hereby incorporated by reference in its entirety.

This application also related to PCT application no. PCT/US16/57334 (Atty docket no. 712-002.424-1/CCS-0151), filed 17 Oct. 2016, entitled “Opportunities for recovery augmentation process as applied to molybdenum production,” which is also hereby incorporated by reference in its entirety.

This application also related to PCT application no. PCT/US16/37322 (Atty docket no. 712-002.425-1/CCS-0152), filed 17 Oct. 2016, entitled “Mineral beneficiation utilizing engineered materials for mineral separation and coarse particle recovery,” which is also hereby incorporated by reference in its entirety.

This application also related to PCT application no. PCT/US16/62242 (Atty docket no. 712-002.426-1/CCS-0154), filed 16 Nov. 2016, entitled “Utilizing engineered media for recovery of minerals in tailings stream at the end of a flotation separation process,” which is also hereby incorporated by reference in its entirety.

This application also relates to PCT application no. PCT/US12/12689, filed 9 Jan. 2017 (Docket no. 712-002.428-1/CCS-0158) entitled “Recovery media for mineral processing, using open cell or reticulated foam having 3-dimensional functionalized open-network structure for selective separation of mineral particles in an aqueous system”, which claims benefit to provisional patent application Ser. No. 62/276,051, filed 7 Jan. 2016 (Docket no. 712-002.428/CCS-0158), entitled “Novel recovery media for mineral processing,” both of which are hereby incorporated by reference in its entirety.

All of the PCT applications and corresponding US patents are hereby incorporated by reference in their entirety.

I claim:

1. A method of measuring a surface area of a collection surface of collection media, comprising:
rendering the collection surface hydrophobic;
contacting the collection surface with an aqueous mixture containing hydrophobic particles so as to achieve a single layer of the hydrophobic particles on the collection surface, and
determining the surface area of the collection media based on the number or mass of the hydrophobic particles in the single layer.

2. A method according to claim 1, wherein the hydrophobic particles includes mineral particles.

3. A method according to claim 1, wherein the collection surface includes a foam, or a three-dimensional open-cell structure.

4. A method according to claim 1, wherein the method further comprises determining and comparing the mass of the collecting surface without the single layer and the mass of the collection surface with the single layer.

5. A method according to claim 1, wherein the method includes functionalizing the collection surface with poly(dimethylsiloxane), fluoroarylsilane.

6. A method according to claim 1, wherein the collection surface may be made of a hydrophobic material.

7. Apparatus for determining a surface area of collection media having a complex collection surface with a surface area, comprising:
a signal processor or processing module configured to:
receive signaling containing information about a weight of collection media having a complex collection surface with a surface area for attaching mineral particle of interest; and
determine corresponding signaling containing information about the surface area derived from a calibration table storing known relationships between known weights of known collection media having known complex collection surfaces with known surface areas, based upon the signaling received.

8. Apparatus according to claim 7, wherein the collection media is macroscopic objects that have a complex geometry and a macroscopic pore structure.

9. Apparatus according to claim 8, wherein the macroscopic objects are reticulated polymeric foam having the complex geometry and the macroscopic pore structure.

10. Apparatus according to claim 7, wherein the weight determined is based upon a measurement related to a monolayer of hydrophobic particle adhering to the complex collection surface.

11. Apparatus according to claim 7, wherein the weight determined is based upon a measurement related to a coating of a silicon polymer sprayed on the complex collection surface for attracting the mineral particle of interest.

12. Apparatus according to claim 7, wherein the surface area determined is based upon measurements related to a monolayer of hydrophobic particle adhering to the known complex collection surfaces.

13. Apparatus according to claim 7, wherein the surface area determined is based upon measurements related to a coating of a silicon polymer sprayed on the known complex collection surfaces for attracting the mineral particle of interest.

14. Apparatus according to claim 7, wherein the weight of collection media having the complex collection surface with the surface area for attaching mineral particle of interest includes a coating weight of the coating of the silicon polymer sprayed on the complex collection surface for attracting the mineral particle of interest.

15. Apparatus according to claim 7, wherein the apparatus comprises a memory or memory module configured to store the calibration table.

16. Apparatus according to claim 14, wherein the memory or memory module is configured to respond to look-up signaling containing information about the weight of the collection media, and provide calibrated signaling containing information about the surface area of the collection media weighed.
